(19) United States
(12) Patent Application Publication
(10) Pub. No.: US 2025/0310126 A1
(43) Pub. Date: Oct. 2, 2025

(54) UPDATING DIGITAL CERTIFICATES OF AN ELEVATOR SYSTEM WITH A MOBILE TERMINAL

(71) Applicant: Inventio AG, Hergiswil (CH)

(72) Inventor: Claudio Colombano, Beckenried (CH)

(21) Appl. No.: 18/862,997

(22) PCT Filed: May 2, 2023
(86) PCT No.: PCT/EP2023/061472

§ 371 Date: Nov. 5, 2024

(30) Foreign Application Priority Data
May 12, 2022 (EP) 22172870.2

(51) Int. Cl. H04L 9/32

(52) U.S. Cl. CPC H04L 9/3263

(57) ABSTRACT

A method for automatically updating at least one digital certificate of an elevator system uses a mobile terminal, wherein the digital certificate is used for authenticating a communication established within or with the elevator system. The method includes the steps: connecting the mobile terminal to the elevator system to allow the mobile terminal to check the time validity of the digital certificate of the elevator system; and generating a human-perceptible signal to indicate a check result if the time validity of the digital certificate is expired or will expire by a predefined time-limit.

### FIELD

The present invention relates to a method for automatically updating at least one digital certificate of an elevator system with a mobile terminal, and such a mobile terminal and elevator system. This invention further relates to a computer program comprising instructions, which can be carried out by this kind of mobile terminal or elevator system. This invention relates also to a computer readable medium comprising such a computer program.

### BACKGROUND

Passenger transport systems like elevators are used to transport people within buildings or structures and are permanently installed for this purpose. A passenger transport system normally has various stationary components and displaceable components, the operation of which is usually controlled and/or coordinated by an internal or external controller. Therefore, the controller and the components need to meet high safety requirements. For example, it must be ensured that the controller is always able to control the operation of an elevator system in such a way that the passengers and/or the integrity of the elevator system are not endangered. It has also to be ensured that the controller itself cannot be manipulated without authorization.

A digital certificate is a file or electronic document used to prove the validity of a public key that proves the authenticity of a device, a server, or a user through a cryptography and a public key infrastructure (PKI) which is an arrangement for binding public keys with respective entities of a network. The PKI may sign and authorize a digital certificate. In an elevator system there are many entities like controllers and components that are authenticated respectively with a digital certificate in order to transmit sensitive data while ensuring data security. The certificate authentication may help elevators or service centers to ensure that only trusted devices and users may communicate with or operate the elevators. However, a digital certificate normally is only valid for a period of a certain time. Thus, it is to require renewal to remain valid before a digital certificate becomes invalid. An expired digital certificate will result in loss of protection for data saved in an elevator or transmitted to or from an elevator. Moreover, a device or external terminal with an invalid digital certificate should not be authenticated to communicate with an elevator.

Using conventional techniques to update or change digital certificates, a device needs to be manually paired with a server or a computer to establish a trusted connection between them, wherein the manual pairing process needs to be performed separately for each server or computer. Modern security dictates, for example, mutual authentication that is usually performed by exchange of authenticated certificates. Mutual authentication is a desired characteristic in verification schemes that transmit sensitive data. Mutual authentication, also known as two-way authentication, is a security process in which entities authenticate each other before actual communication occurs. In a network, this requires that two devices must provide digital certificates to prove their identities. However, such an authentication may have some weakness since manually pairing is troublesome and error prone. If it has been forgotten to pair a couple of network members, it might cause not obvious malfunctions of elevators, for example, when a user has forgotten to renew or update a digital certificate before it expires. If all components and units of an elevator or most of them are paired via a gateway, the gateway could be overloaded so that it might not support a broadband communication. On the other hand, the individual components should provide a suitable interface for such pairing process. This will make the whole elevator system costly and expensive.

### SUMMARY

An object of the invention is to ensure a safe access of a mobile device to an elevator system and the safety of data communication within or with the elevator system.

This object is solved by the advantageous embodiments and further developments of the invention given in the following description.

According to the first aspect of the invention, a method is proposed for automatically updating or renewing at least one digital certificate of an elevator system, wherein the digital certificate is used for authenticating a communication established within or with the elevator system. The method may comprise the following steps:
connecting a mobile terminal to the elevator system to allow this mobile terminal to check the time validity of the digital certificate of the elevator system, and
generating a human-perceptible signal to indicate a check result if the time validity of the digital certificate is expired or will expire until a predefined time-limit. The predefined time-limit can be the time of a next expected or scheduled inspection of the elevator system. The human-perceptible signal is generated by either the elevator system or the mobile terminal.

An advantage of the invention consists in particular in the fact that a digital certificate of an elevator system, for example saved in an elevator component, can be protected from inadvertent or unexpected expiration. For instance, although the digital certificate is currently available but will expire before the next inspection date so that the elevator system cannot be inspected next time. However, a technician would not recognize this problem until then. On the other hand, for maintenance or operation, a variety of technologies for implementing data communication via a mobile terminal has emerged. With the help of a mobile terminal like a smartphone, which comprises normally a human-machine-interface (HMI), for example a display, it is convenient for technicians to perform the proposed method, because most of the components of an elevator have no display.

According to an embodiment in respect of the first aspect of the present invention, the elevator system comprises a local network (e.g., LAN) with at least one device connected with this local network. Such a device can be a component of the elevator system or any other peripheral device/unit. Every device and/or the mobile terminal may comprise the same or a different digital certificate of the elevator system. The method may comprise a further step: identifying the device and/or the mobile terminal whose digital certificate(s) need(s) to be updated. The mobile terminal, for example, is used for accessing and/or controlling the elevator system. Such a digital certificate can be protected or encrypted by a public key which is, for example, available for the elevator system, the mobile terminal, and the local network. Each of these devices may comprise its own digital certificate, so they can be identified and communicate with the other devices via the local network to transmit secure data. They may of course also communicate with external devices via a public network, for example, to send ordinary non-secure data.

According to an embodiment in respect of the first aspect of the present invention, the method comprises further a step: requesting to update the digital certificate when generating the human-perceptible signal. The updating can be initiated automatically or manually by a user of the mobile terminal. This request may be a visual or auditory message and include instructions and guidance on how to update or renew the current digital certificate.

According to a further embodiment in respect of the first aspect of the present invention, if the time validity of the digital certificate is expired or will expire until a predefined time-limit, the method comprises further following steps:
generating a new digital certificate,
sending the new digital certificate with a signature request to a public key infrastructure (PKI) to authenticate the new digital certificate,
signing the new digital certificate with a private key at the PKI. The private key can be either generated at that time or saved in advance in the PKI, wherein the private key is assigned to or associated with a certain recipient of the new digital certificate, because the mobile terminal may have identified which recipient(s) need(s) a new digital certificate, when checking the validity of the digital certificate, so that the signature request may comprise the identity or identities of such recipient(s),
obtaining the signed new digital certificate from the PKI, and
distributing the signed new digital certificate to update the digital certificate.

The public key infrastructure, for example a remote server, can sign, storage, and distribute respective digital certificates which are used to identify or authenticate certain entities. The purpose of a PKI is to manage public and/or private keys used for data encryption, identity management, certificate distribution, certificate revocation, and certificate management. For example, the private key is kept secret by the owner and the public key can be shared with the network or other entities. Therefore, transmitted digital certificates encrypted by a private key can only be decrypted at the corresponding recipient.

According to a further embodiment in respect of the first aspect of the present invention, the mobile terminal, the elevator system, and/or the device as recipient is able to verify the received, signed new digital certificate with a public key. Such a public key can be saved respectively in the recipients. If the signed new digital certificate is sent from the PKI and encrypted by a public key, each component/device of the elevator system, the device attached to the elevator system, or the mobile terminal may receive and verify this new digital certificate, because they comprise the public key already and may decrypt the received new digital certificate. As they as recipients are associated with the generated private key, it is ensured that the transmitted new digital certificates can only be read by the approved recipient. Accordingly, the recipient may comprise corresponding means to decode data which is encoded with the private key.

A confirmation signal can be generated by the mobile terminal or by the elevator to instruct that the digital certificate has been updated or renewed. If the time validity of the digital certificate lasts at least until or including a predefined time-limit, another human-perceptible signal can be generated to confirm that the digital certificate is still valid.

According to the second aspect of the invention, a mobile terminal is provided for accessing and/or controlling an elevator system which comprises at least one digital certificate for authenticating a communication established within or with the elevator system. The mobile terminal is able to be connected with the elevator system in this manner that the mobile terminal may check the time validity of the digital certificate of the elevator system, and the mobile terminal generates a human-perceptible signal for indicating a check result if the time validity of the digital certificate is expired or will expire until a predefined time-limit.

According to an embodiment in respect of the second aspect of the present invention, the elevator system comprises a local network (e.g., LAN) with at least one device connected with this local network. Such a device can be a component of the elevator system or any other peripheral device/unit. Every device and/or the mobile terminal may comprise the same or a different digital certificate of the elevator system. Like the method described above, the mobile terminal in this case may identify the device and/or the mobile terminal whose digital certificate(s) need(s) to be updated.

According to an embodiment in respect of the second aspect of the present invention, the mobile terminal may request to update or renew the digital certificate when generating the human-perceptible signal. The updating can be initiated automatically or manually by a user of the mobile terminal. This request may be a visual or auditory message and include instructions and guidance on how to update or renew the digital certificate.

According to an embodiment in respect of the second aspect of the present invention, if the time validity of the digital certificate is expired or will expire until a predefined time-limit, the mobile terminal may
generate a new digital certificate and a signature request,
send the new digital certificate with a signature request to a PKI to authenticate the new digital certificate,
obtain the signed new digital certificate from the public key infrastructure, and
distribute the signed new digital certificate to the lift elevator system for updating the digital certificate.

The elevator components and the elevator normally are not connected with a wide area network (WAN), for example internet, extending over a large geographic area. With help of a mobile terminal like a smartphone which is able to be connected to a WAN, it is possible to update the digital certificates saved in such components or such an elevator in an easy way.

According to a further embodiment in respect of the second aspect of the present invention, the mobile terminal as recipient is able to verify the received, signed new digital certificate with a public key which is saved in the mobile terminal, when the transmitted signed new digital certificate is encrypted by the public key.

Generally, it is difficult or impossible that a request or command from any mobile terminal is directly acceptable by an elevator system. That must be authenticated to identify the mobile terminal or its user. Thus, the mobile terminal may comprise also an own digital certificate for connecting with the elevator system so that the mobile terminal may check the time validity of its own digital certificate and update or renew this digital certificate in the same way as the mobile terminal does for the elevator system.

Like described above, if the received new digital certificate is signed already with the private key in PKI, this certificate then is only available or can only be decrypted in respective components/devices or in the mobile terminal, because they are associated with a different private key.

According to the third aspect of the invention, an elevator system comprises at least one digital certificate for authenticating a communication established within or with the elevator system, wherein the elevator system is connectable with a mobile terminal in this manner that the mobile terminal may check the time validity of the digital certificate of the elevator system, and the elevator system generates a human-perceptible signal for indicating a check result if the time validity of the digital certificate is expired or will expire until a predefined time-limit.

According to an embodiment in respect of the third aspect of the present invention, the elevator system comprises a local network with at least one device connected with this local network, and every device and/or the mobile terminal comprise(s) the same or a different digital certificate of the elevator system, wherein the mobile terminal may access and/or control the elevator system.

According to an embodiment in respect of the third aspect of the present invention, the elevator system may request to update or renew the digital certificate when generating human-perceptible signal.

According to an embodiment in respect of the third aspect of the present invention, the elevator system may
generate a new digital certificate and a signature request,
send the new digital certificate with a signature request to a public key infrastructure (PKI) to authenticate the new digital certificate,
obtain the signed new digital certificate from the public key infrastructure, and
distributing the signed new digital certificate to the elevator system to update the digital certificate. If the mobile terminal comprises also a digital certificate to be updated, the elevator system may distribute the signed new digital certificate to the mobile terminal for replacing the digital certificate.

According to an embodiment in respect of the third aspect of the present invention, the elevator system as a recipient is able to verify the received, signed new digital certificate with a public key which is saved in the elevator system, when the transmitted signed new digital certificate is descripted by the public key.

According to the fourth aspect of the invention, a computer program is provided comprising instructions, which can be carried out through a method according to the first aspect of the invention, by the mobile terminal according to the second aspect of the invention, or by the elevator system according to the third aspect of the invention.

According to the fifth aspect of the invention, a computer readable medium is provided comprising the computer program according to the fourth aspect of the invention.

Further advantageous features of the invention can be seen from the following exemplary explanation thereof with reference to the drawings. However, neither the drawings nor the description shall be interpreted as limiting the invention.

### DESCRIPTION OF THE DRAWINGS

FIG. 1 shows a block diagram of an elevator system and a mobile terminal according to the afore-mentioned invention,

FIG. 2 shows a flow chart illustrating an embodiment of the method according to the afore-mentioned invention to update or renew a digital certificate of an elevator system,

FIG. 3 shows an embodiment of the method according to the invention,

FIG. 4 shows another embodiment of the method according to the invention, and

FIG. 5 shows a computer readable medium and a computer program according to the invention.

### DETAILED DESCRIPTION

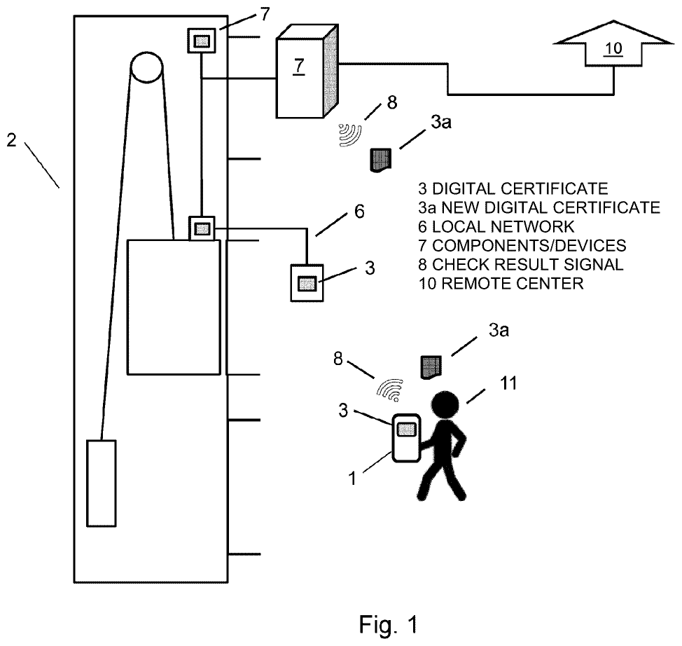

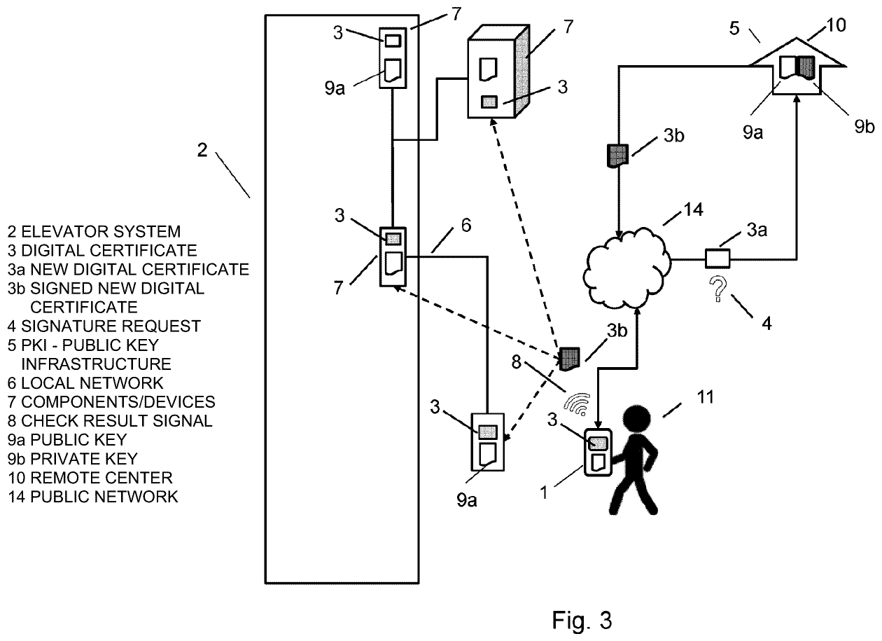

FIG. 1 shows an elevator system 2 and a mobile terminal 1 that may communicate with each other. The mobile terminal 1 is provided with a display so that it is convenient for technicians to perform a maintenance or an inspection for the elevator system 2. The mobile terminal 1 may also access or control the elevator system 2, wherein the mobile terminal 1 comprises a digital certificate 3 for authenticating a communication established with the elevator system 2. The elevator system 2 comprises a local network (e.g., LAN) 6, via this local network the components/devices 7 of the elevator system 2 are connected with each other. Additionally, such a device 7 can be any other device which may communicate with the elevator system 2, for example, the mobile terminal 1 can be also connected to this network. Every device/component 7 and the mobile terminal 1 comprise the same or their own different digital certificates 3 so that they may be identified and authenticated to communicate with each other or with external devices like a remote center 10 or a public network 14 (FIG. 3). The mobile terminal 1 is able to check the time validity of the digital certificate 3 of the elevator system 2 in order to avoid the situation that the elevator system 2 cannot be maintained or inspected next time, because although a digital certificate 3 is currently available but will expire before the next inspection date.

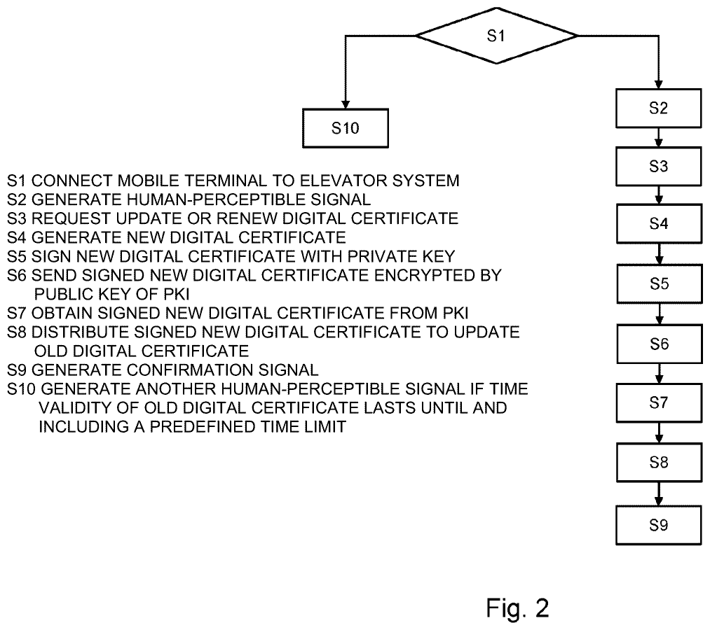

To update or renew a digital certificate 3 of an elevator system 2 a method is explained below with reference to FIG. 2, it is to execute following steps S1 to S10:
S1: connecting the mobile terminal 1 to the elevator system 2 in order to allow the mobile terminal 1 to check the time validity of the digital certificate 3 saved in a device/component 7 of the elevator system 2. Additionally, it can be identified which digital certificates 3 are to be updated.
S2: generating a human-perceptible signal 8 to indicate a check result if the time validity of the digital certificate 3 is expired or will expire until a predefined time-limit,
S3: requesting to update or renew the digital certificate 3 when the human-perceptible signal is generated, wherein the updating can be initiated automatically or manually by the user 11 of the mobile terminal 1. The request may provide visual or auditory message including instructions and guidance on how to update or renew the digital certificate,
S4: generating a new digital certificate 3a and sending the new digital certificate 3a with a signature request 4 (FIG. 3) to a public key infrastructure (PKI) 5 (FIG. 3) to authenticate the new digital certificate 3a. The signature request 4 comprises the identities of the elevator devices/components 7 or of the mobile terminal 1 whose digital certificates 3 need to be updated,
S5: signing the new digital certificate 3a with a private key 9b (FIG. 3) at the PKI 5, the private key 9b is generated dynamically at that time or has been already saved in the PKI, wherein the private key is assigned to or associated with at least one certain recipient of the new digital certificate 3a. The certain recipient means one or more of the identified elevator devices/components 7 or the mobile terminal 1,
S6: sending the signed new digital certificate 3b (FIG. 3) encrypted by a public key 9a (FIG. 3) of the PKI,
S7: obtaining the signed new digital certificate 3b from the PKI 5,
S8: distributing the signed new digital certificate 3b according to the afore-mentioned identities to the respective recipient to update the old digital certificate 3,
S9: generating a confirmation signal to instruct that the digital certificate 3 has successfully updated or renewed, and
S10: generating another human-perceptible signal 8 if the time validity of the digital certificate 3 lasts at least until and including a predefined time-limit.

In above steps, the transmission of the digital certificate 3a, 3b like the step S6 is always protected by encryption with a public key 9a so that the mobile terminal 1, the elevator system 2, PKI 5, the elevator device/component 7, or a periphery device connected to the elevator system 2 as a recipient may verify the received new digital certificate 3a, 3b with the respective public key 9a saved in them, wherein such public keys 9a as a root certificate may identify a certificate authority.

In FIG. 3, an embodiment of the method is described with reference to the elevator system 2 and the mobile terminal 1. In this embodiment, the mobile terminal 1 may check the time validity of the digital certificates 3 of the elevator system 2. For example, the digital certificates 3 to be updated are shown shaded, while the digital certificate 3 which does not need updating is not shaded. In the meantime, the mobile terminal 1 may identify which digital certificates are to be updated. The mobile terminal 1 further may raise an alarm in form of a human-perceptible signal 8 when at least one of the digital certificates 3 is expired or will expire until a predefined time-limit. In the meantime, the mobile terminal 1 may request the user 11 to update the digital certificate 3. The updating can be initiated automatically or manually by the user 11 of the mobile terminal 1. In case of an automatic updating, the user 11 only needs to confirm this request. If the user 11 has to manually update the digital certificate 3, he may follow an instruction or guidance provided by the mobile terminal 1.

Then the mobile terminal 1 generates and sends a new digital certificate 3a with a signature request 4 to a PKI 5 for authenticating this new digital certificate 3a, wherein the signature request 4 comprises the identities of the elevator devices/components 7 or of the mobile terminal 1 whose digital certificates 3 need to be updated. In the PKI, the new digital certificate 3a can be signed with a private key 9b which is associated with a certain recipient. Then the PKI 5 sends this signed new digital certificate 3b encrypted with a public key 9a back to the mobile terminal 1. The mobile terminal 1 receives the signed new digital certificate 3b from the PKI 5 and may verify this signed new digital certificate 3b, when the signed new digital certificate 3b is decrypted by the public key 9a saved in the mobile terminal 1. In this case, even the mobile terminal 1 cannot read the signed new digital certificate 3b if the mobile terminal 1 is not assigned as the recipient to this signed new digital certificate 3b which is protected by the private key 9b. Then, the mobile terminal 1 just distributes this signed new digital certificate 3b according to the identities to the elevator system 2 for replacing the respective digital certificates 3. This distribution may also be protected by the public key 9a. If the mobile terminal 1 comprises an own digital certificate 3, the mobile terminal 1 may also check and update/renew its own digital certificate 3 in the same way as performing for the elevator system 2.

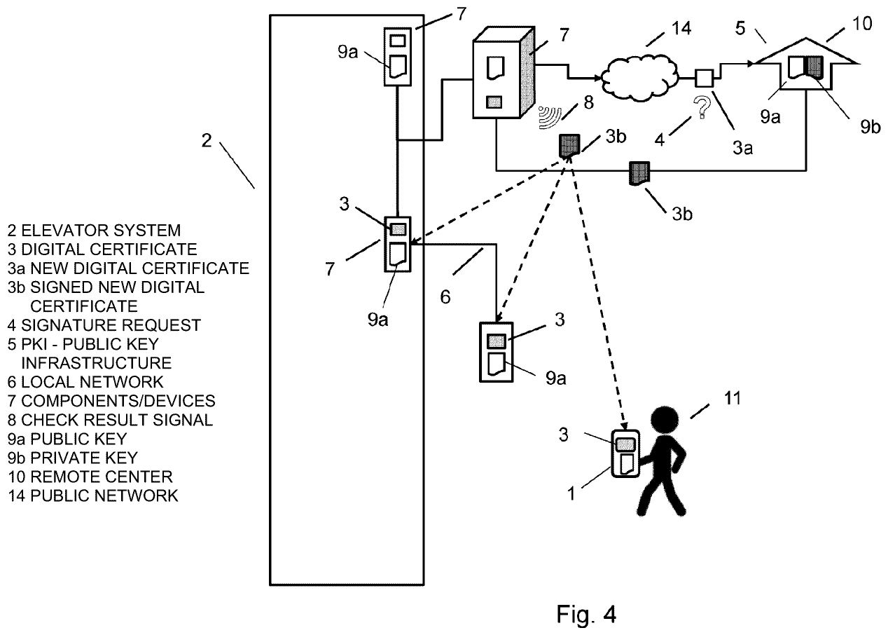

In comparison to FIG. 3, the embodiment shown in FIG. 4 is different just in that the elevator system 2 may take over some tasks or functions of the mobile terminal 1. After the mobile terminal 1 has checked the time validity of the digital certificate 3 of the elevator system 2, upon the check result, the elevator system 2 may generate a human-perceptible signal 8 to indicate this check result if the time validity of the digital certificate 3 is expired or will expire until a predefined time-limit. In this embodiment, the mobile terminal 1 may identify which digital certificates are to be updated and inform the elevator system 2 about the identifies of the respective devices/components 7. If the digital certificate 3 of the mobile terminal 1 needs also updating, the mobile terminal 1 may send its own identity to the elevator system 2. After then, the elevator system 2 may also send a request to the mobile terminal 1 to ask the user 11 for updating/renewing the digital certificate 3. The updating can be initiated automatically or manually by the user 11 of the mobile terminal 1. In case of an automatic updating, the user 11 needs just to confirm this request. If the user 11 has to manually update the digital certificate 3, he may follow an instruction or guidance provided by a visual or auditory information which is generated by or sent from the elevator system 2 to the mobile terminal 1. In this case, the individual components 7 of the elevator system 2 do not need to be provided with a display to show such an instruction or guidance.

Then the elevator system 2 generates and sends a new digital certificate 3a with a signature request 4 to a PKI 5 for authenticating this new digital certificate 3a. The signature request 4 comprises the identities of the elevator devices/components 7 or of the mobile terminal 1 whose digital certificates 3 need to be updated. In the PKI, the new digital certificate 3a can be signed with a private key 9b generated or saved there already. The private key 9b is associated with a certain recipient, namely the elevator system 2, or one or more of the elevator components/devices 7 or the mobile terminal 1. The elevator system 2 receives the signed new digital certificate 3b from the PKI 5, and then distributes this signed new digital certificate 3b according to renew/replace the digital certificate 3 of the elevator system 2 and/or of the mobile terminal 1. Between the PKI 5, the elevator system 2 and the mobile terminal 1, the new digital certificate 3a, 3b is always sent by protection with a public key 9a which is saved in them respectively.

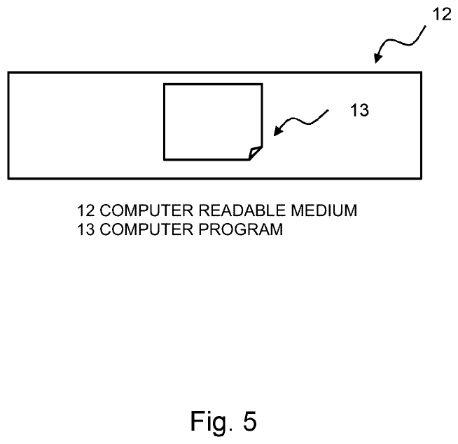

FIG. 5 shows a computer readable medium 12 comprising a computer program 13 which can be carried out by the mobile terminal 1 or by the elevator system 2. Examples of the computer readable medium 12 can be a magnetic disk, card (e.g., USB), tape, and drum, punched card and paper tape, optical disc, barcode and magnetic ink character.

In accordance with the provisions of the patent statutes, the present invention has been described in what is considered to represent its preferred embodiment. However, it should be noted that the invention can be practiced otherwise than as specifically illustrated and described without departing from its spirit or scope.

1-16. (canceled)

17. A method for automatically updating a digital certificate of an elevator system, wherein the digital certificate is used for authenticating a communication established within or with the elevator system, the method comprising steps of:
connect a mobile terminal to the elevator system to enable the mobile terminal to check a time validity of the digital certificate of the elevator system; and
generate a human-perceptible signal indicating a check result when the time validity of the digital certificate is expired or will expire by a predefined time limit.

18. The method according to claim 17 wherein the elevator system includes a local network and a device connected with the local network, the device including the digital certificate, and wherein the device is identified in the check result.

19. The method according to claim 17 wherein the mobile terminal includes the digital certificate and the mobile terminal is identified in the check result.

20. The method according to claim 17 wherein the elevator system includes a local network and a device connected with the local network, wherein the device includes the digital certificate or a different digital certificate and the mobile terminal includes the digital certificate or the different digital certificate, and wherein the check result identifies the device and/or the mobile terminal when the time validity of the included one of the digital certificate and the different digital signal is expired or will expire by the predefined time limit.

21. The method according to claim 17 including request to update the digital certificate when the human-perceptible signal is generated.

22. The method according to claim 17 including, when the time validity of the digital certificate is expired or will expire by the predefined time limit, performing steps of:
generate a new digital certificate;
send the new digital certificate with a signature request to a public key infrastructure (PKI) to authenticate the new digital certificate;
sign the new digital certificate with a private key at the PKI;
obtain the signed new digital certificate from the PKI; and
distribute the signed new digital certificate and update the digital certificate with the signed new digital certificate.

23. The method according to claim 22 wherein the mobile terminal, the elevator system and/or a device of the elevator system receives the signed new digital certificate and verifies the signed new digital certificate with a public key.

24. A mobile terminal for accessing and/or controlling an elevator system, the elevator system including a digital certificate for authenticating a communication established within or with the elevator system, wherein when the mobile terminal is connected with the elevator system the mobile terminal is adapted to check a time validity of the digital certificate and generate a human-perceptible signal indicating a check result when the time validity of the digital certificate is expired or will expire by a predefined time limit.

25. The mobile terminal according to claim 24 wherein the elevator system includes a local network and a device connected with the local network, the device and the mobile terminal including the digital certificate or a different digital certificate, and wherein the mobile terminal is adapted to identify the device and/or the mobile terminal when the digital certificate and/or the different digital certificate is expired or will expire by the predefined time limit.

26. The mobile terminal according to claim 24 wherein the mobile terminal requests to update the digital certificate when generating the human-perceptible signal.

27. The mobile terminal according claim 24 wherein, when the time validity of the digital certificate is expired or will expire by the predefined time limit, the mobile terminal:
generates a new digital certificate;
sends the new digital certificate with a signature request to a public key infrastructure (PKI) for authenticating the new digital certificate;
obtains a signed new digital certificate from the PKI; and
distributes the signed new digital certificate to the elevator system and updates the digital certificate with the signed new digital certificate.

28. The mobile terminal according to claim 27 wherein the mobile terminal verifies the signed new digital certificate with a public key saved in the mobile terminal.

29. An elevator system including a digital certificate for authenticating a communication established within or with the elevator system, wherein a mobile terminal connected to the elevator system checks a time validity of the digital certificate, and the elevator system generates a human-perceptible signal indicating a check result when the time validity of the digital certificate is expired or will expire by a predefined time limit.

30. The elevator system according to claim 29 wherein the elevator system includes a local network and a device connected with the local network, the device and the mobile terminal including the digital certificate or a different digital certificate, and wherein the mobile terminal is adapted to access and/or control the elevator system.

31. The elevator system according to claim 29 wherein the elevator system requests to update the digital certificate when generating the human-perceptible signal.

32. The elevator system according to claim 29 including a controller that:
generates a new digital certificate and a signature request;
sends the new digital certificate with the signature request to a public key infrastructure (PKI) for authenticating the new digital certificate;
obtains a signed new digital certificate from the PKI; and
distributes the signed new digital certificate to the elevator system and/or the mobile terminal to update the digital certificate with the signed new digital certificate.

33. The elevator system according to claim 32 wherein the elevator system verifies the signed new digital certificate with a public key that is saved in the elevator system.

34. A computer program comprising computer-readable instructions, the computer program stored on a non-transitory computer-readable medium, the instructions when executed by a processor cause an elevator system and a mobile terminal to carry out the steps of the method according to claim 17.
